(19) United States
(12) Patent Application Publication
(10) Pub. No.: US 2026/0079002 A1
(43) Pub. Date: Mar. 19, 2026

(54) CONTACTLESS ONLINE FUSION DRAW GLASS THICKNESS MEASUREMENT SYSTEM AND METHOD

(71) Applicant: CORNING INCORPORATED, CORNING, NY (US)

(72) Inventor: SERGEY Y POTAPENKO, PAINTED POST, NY (US)

(21) Appl. No.: 18/871,239

(22) PCT Filed: Jun. 6, 2023
(86) PCT No.: PCT/US2023/024504

§ 371 Date: Dec. 3, 2024

Related U.S. Application Data
(60) Provisional application No. 63/352,725, filed on Jun. 16, 2022.

(51) Int. Cl. G01B 11/06; G01B 11/24; G01B 11/245

(52) U.S. Cl. CPC G01B 11/0691; G01B 11/0675; G01B 11/2441; G01B 11/245

(57) ABSTRACT

A system that measures thickness of a glass includes a laser that transmits a laser beam through the glass; a sensor that senses an interference pattern of the laser beam through the glass; and a computer that processes sensor data corresponding to the interference pattern received from the sensor to determine the thickness of the glass.

### CROSS-REFERENCE TO RELATED APPLICATION

This application claims the benefit of priority under 35 U.S.C. § 119 of U.S. Provisional Application Ser. No. 63/352,725 filed on Jun. 16, 2022, the content of which is relied upon and incorporated herein by reference in its entirety.

### BACKGROUND

The present disclosure generally relates to systems and methods to measure the thickness of glass and, more specifically, to in-line systems and methods to measure the thickness of a moving glass sheet without contacting the glass sheet.

Glass substrates are commonly used to manufacture a variety of electronic devices including electronic displays such as liquid crystal displays (LCD) and organic light-emitting displays (OLED). Electronic displays are provided in devices such as smart phones, tablets, laptop computers, desktop computer monitors, and televisions. As the performance and demand for such devices increases, so does the need to efficiently mass produce high quality glass substrates utilized to make such devices. Thin glass substrates are typically manufactured using a down draw process such as, for example, a fusion draw process. The fusion draw process produces continuous glass ribbons that have surfaces with superior flatness and smoothness when compared to glass ribbons produced by other methods. The continuous glass ribbons can be sectioned into glass sheets that are subsequently used as substrates to process into electronic devices.

While fusion draw processes form thin glass sheets with the desired surface properties, the thickness of the glass sheets can be difficult to control, particularly as the glass sheets become thinner. Accordingly, manufacturers of glass sheets are continuously improving their glass manufacturing processes and systems so they can manufacture glass sheets that meet the performance needs of electronic display manufacturers that desire glass sheets with increased size and quality at decreased thickness.

As a result, on-line thickness measurements become increasingly more difficult to perform as the size of the glass sheets increases and the overall thickness of the glass sheets decreases. Both of these factors create a certain amount variance in the position and/or the angular orientation of the glass sheets during manufacture and impact the accuracy of in-line thickness measurements.

Glass thickness measurement is necessary in fusion glass production for both quality control and as feedback for process control. This requires in-line measurement for quick reaction to the production process and to remove sub-quality or no-good product from further processing. The thickness measurements can be performed with a suitable system soon after a glass ribbon is separated into individual glass sheets. The measurements occur when the glass sheets are conveying in a direction perpendicular to vertical fusion draw. The glass sheets undergo elastic shape deformation due to influence of the environment and intrinsic non flatness of the glass sheet. The deformation changes the distance between the thickness measurement sensor and the measurement point on the glass sheet. To keep the distance within the working range of measurement sensor or stylus that physically contacts the glass sheet as a thickness measurement sensor, the glass sheet or sensor position must be maintained within a predetermined range from the measurement sensor.

Contact by glass handling parts to a glass sheet is usually done at the edges, outside of the usable area to minimize damage to the usable area. However, any contact may cause breakage of the glass. The current trend of increasing glass flow and reducing glass thickness makes this issue more significant. Reduction of glass breakage is considered now as one of the major factors in reducing the production cost.

Another method described in U.S. PG Pub. 2012/0127487 uses an optical measurement technique with a movable stage to follow the glass measurement point while it is being conveyed. In this technique, an edge detector is utilized to determine an initial separation distance between a leading edge of the first surface plane of the glass sheet and an optical measurement head as the glass sheet is conveyed in a conveyance direction. Utilizing the value of the separation distance, a control unit adjusts the position of the optical measurement head relative to the first surface plane of the glass sheet such that the first surface plane is within the working range of the optical measurement head. However, it has been found that this technique has a problem accurately determining the leading edge of the glass sheet and has relatively high cost.

Accordingly, a need exists for alternative methods and apparatuses tolerant to variations of glass sheets size, position, and orientation for in-line thickness measurement of glass sheets during manufacture.

### SUMMARY OF THE DISCLOSURE

A conventional glass sheet thickness measurement method using an optical sensor requires containing the glass sheet within a limited working range, which causes unwanted glass breakage. The disclosed method is contactless requiring no additional glass motion restriction.

To overcome the problems described above, embodiments of the present disclosure solve the measurement range limitation by using interference of coherent light (i.e., from a laser) propagated through a glass sheet with portion of the incident light passing through the glass sheet three times. After passing through the front surface, incident laser light partially reflects from the back surface, partially reflects from the front surface, and then exits the glass through the rear surface. Laser light propagated along these two paths creates an interference fringe pattern at the imaging sensor. The problem of phase unwrapping of the interference fringe pattern can be solved by using a beam diverging in the plane perpendicular to the conveyor motion and a line scan sensor creating a virtually collimated beam in the glass motion direction. The increased measurement working range eliminates the need to maintain tight containment of the distance between the glass sheet and a measurement sensor and the glass breakage this may cause. In addition, this method can output a thickness map rather than a conventional single thickness trace. A full sheet thickness map can be measured using a system including a multiple line scan sensor.

Interferometric contactless in-line thickness measurement is made possible by the disclosed phase unwrapping method using specific properties of fusion drawn glass and a special coherent beam shape.

In an embodiment, a system that measures thickness of a glass includes a laser that transmits a laser beam through the glass; an imaging sensor that senses an interference pattern of the laser beam through the glass; and a computer that processes sensor data corresponding to the interference pattern received from the sensor to determine the thickness of the glass.

In one aspect, the glass can be a glass sheet.

The system can further include a conveying system that conveys the glass sheet between the laser and the sensor.

In one aspect, the imaging sensor can be an optical line scan sensor.

The system can further include a band pass filter positioned between the glass and the sensor.

The system can further include a plurality of lasers that each transmits a corresponding laser beam through the glass to a corresponding imaging sensor.

In an embodiment, a method to measure thickness of a glass includes passing a glass sheet in a horizontal direction between a laser and an imaging sensor that senses an interference fringe pattern of laser light emitted from the laser through a portion of the glass; capturing sensor data of the laser light from the imaging sensor by a computer; analyzing the sensor data to locate saddle and focus positions by the computer; normalizing the sensor data by the computer; calculating the normalized sensor data as inverse cosine; obtaining a reference thickness value of the glass; and calculating an absolute thickness of the glass along the horizontal direction using the reference thickness value.

The method can further include calculating a vertical thickness gradient of the glass, wherein the vertical thickness gradient is calculated as:

$$\frac{\partial d ( x , y )}{\partial y} = \frac{d ( x ) Δ y}{{S}_{1} S {n}^{2}} ,$$

where S is a distance from the laser to the sensor, S₁ is a distance from the laser to the glass, n is an index of refraction of the glass, and Δy is a vertical shift of the sensor plane of the center of focus or saddle points.

In an aspect, normalizing the sensor data includes identifying a maximum value and a minimum value of the sensor data and transforming the sensor data such that the maximum value is equal to 1 and the minimum value is equal to −1.

In an aspect, the absolute thickness of the glass is calculated by adding a constant such that a thickness at a reference point is equal to the reference thickness value.

In an embodiment, a non-transitory computer-readable medium including executable instructions that when executed by a processor cause the processor to perform a method including capturing sensor data of laser light that causes an interference fringe pattern when passed through glass and incident to an imaging sensor; analyzing the sensor data to locate saddle and focus positions; normalizing the sensor data; calculating the normalized sensor data as inverse cosine; and calculating an absolute thickness of the glass along the horizontal direction using a reference thickness value of the glass.

In an aspect, the method can further include calculating a vertical thickness gradient of the glass.

In the non-transitory computer-readable medium, the vertical thickness gradient is calculated as:

$$\frac{\partial d ( x , y )}{\partial y} = \frac{d ( x ) Δ y}{{S}_{1} S {n}^{2}} ,$$

where S is a distance from the laser to the sensor, S₁ is a distance from the laser to the glass, n is an index of refraction of the glass, and Δy is a vertical shift in the sensor plane of the center of focus or saddle points.

In the non-transitory computer-readable medium, normalizing the sensor data includes identifying a maximum and a minimum value of the sensor data and transforming the sensor data such that the maximum value is equal to 1 and the minimum value is equal to −1.

In the non-transitory computer-readable medium of claim 12, wherein the absolute thickness of the glass is calculated by adding a constant such that a thickness at a reference point is equal to the reference thickness value.

The above and other features, elements, characteristics, steps, and advantages of the present invention will become more apparent from the following detailed description of preferred embodiments of the present invention with reference to the attached drawings.

### BRIEF DESCRIPTION OF THE DRAWINGS

FIGS. 1 and 2 show a glass thickness measurement system according to an embodiment of the present disclosure.

FIG. 3 shows laser light from the same source propagating through a glass sheet.

FIG. 4 is an image of a fringe pattern.

FIG. 5 is a graph showing the theoretical perceived (effective) glass thickness change versus the distance from the middle of the optical sensor for a 0.5 mm glass sheet.

FIG. 6 shows a glass thickness measurement system according to another embodiment of the present disclosure.

FIG. 7 is a flowchart of a method of contactless thickness measurement of a glass sheet according to an embodiment of the present disclosure.

FIG. 8 is an example of an interference fringe pattern for a thickness measurement using the disclosed method.

FIG. 9 is a graph including a thickness measured on a 250 mm long glass sheet by the disclosed method and with three independent measurements made using a separate measurement sensor.

### DETAILED DESCRIPTION

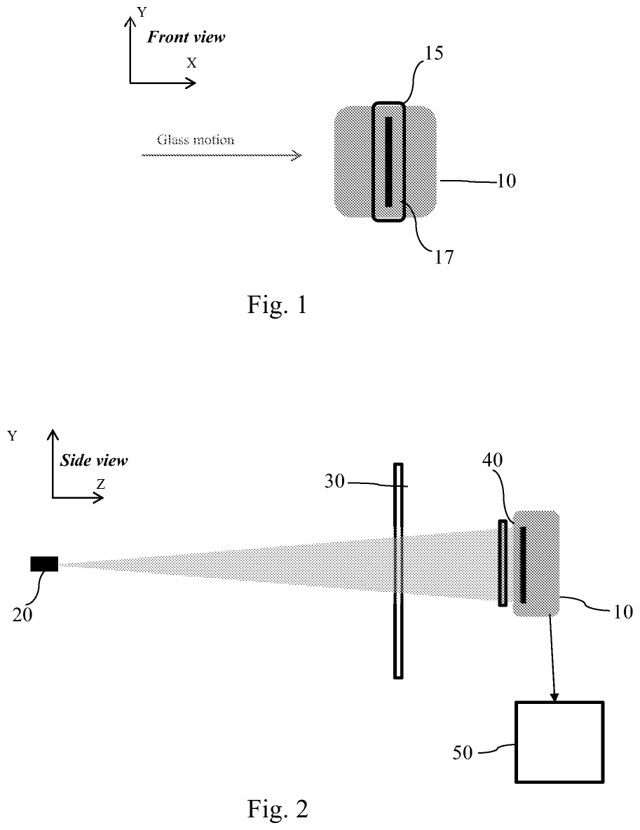

FIGS. 1 and 2 show a system that measures thickness of a glass. In an embodiment of the system, FIGS. 1 and 2 show an exemplary orientation of an imaging optical line scan sensor 10 and laser 20 with respect to conveying motion of a glass sheet 30. FIG. 1 is a front view of the optical line scan sensor 10. As shown in FIG. 1, the glass sheet 30 is moving in an X-direction, represented as left to right. FIG. 2 is a side viewing showing the glass sheet 30 moving in between a laser 20 with emitted radiation directed through the glass sheet 30, through an optional bandpass filter 40, and to the optical line scan sensor 10 that has a sensor surface in the X-Y plane. The laser 20 can be configured to emit a radiation pattern 15 that covers the sensor line 17. As shown in FIG. 2, the optical sensor 10 can be connected to a frame grabber in a computer 50 that can include a memory that stores the sensor data read by the frame grabber and performs the thickness calculations. The computer 50 can be of any suitable configuration including a computer with a processor or network of computers/processors that can store the sensor data and perform the thickness calculations described below.

FIG. 2 is a side view of showing the glass sheet 30 moving in the X-direction, perpendicular to the page, with the laser 20 on one side of the glass sheet 30 that opposes the optical line scan sensor 10 on the other side of the glass sheet 30. Although any suitable distance is possible, the laser 20 can be a distance of 700±500 mm from the glass sheet 30, and the optical sensor 10 can be 150±100 mm from the glass sheet 30.

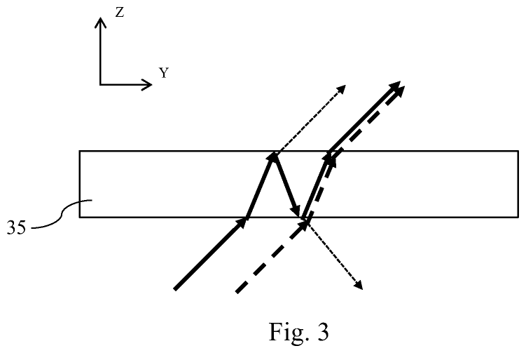

FIG. 3 shows laser light rays from the same source propagating through a glass sheet 35 in the y-z plane. The solid back arrows represent a portion of laser light incident at an angle that passes three times through the glass sheet 35, reflecting from the rear (with respect to the laser) and then front surfaces. The thinner dotted line arrows represent light not internally reflected and transmitting through surfaces of the glass sheet. The thick dashed line arrows represent a portion of the light from the laser that is incident at an angle passing through the glass sheet 35 once without being internally reflected. As a result, the light that is internally reflected and the light that is not reach the optical sensor out of phase with each other. This phase difference will determine the light intensity at this point that be used to calculate the thickness of the glass sheet.

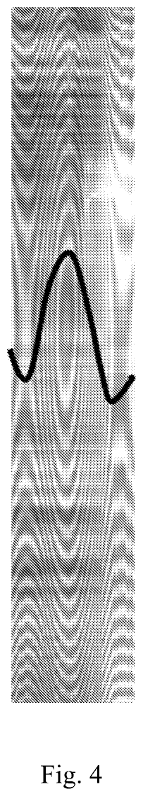

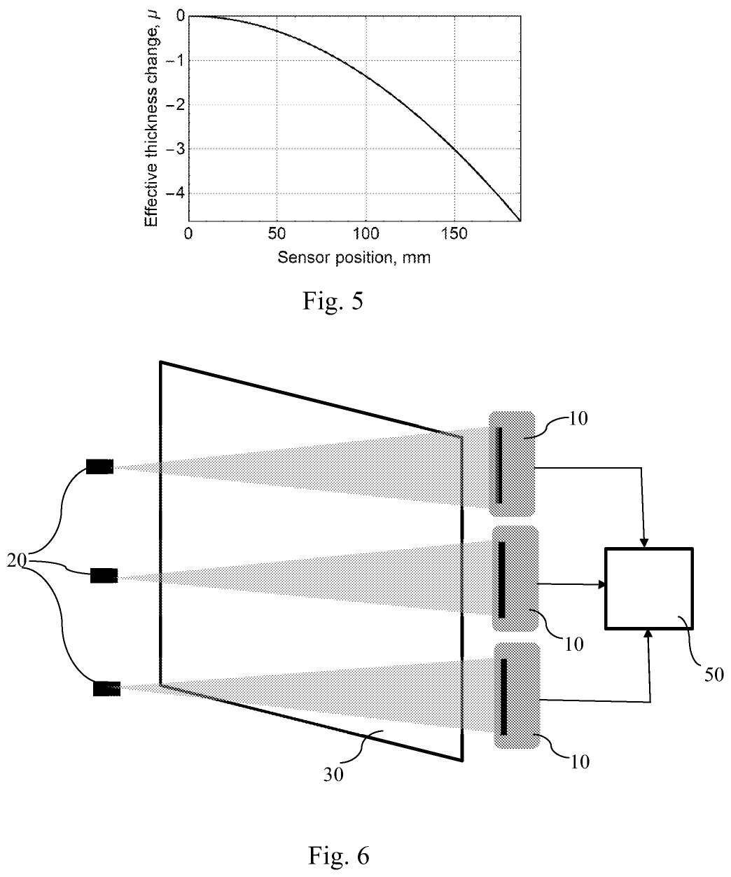

As represented in FIG. 2, the laser light beam is diverging in the vertical direction (y-z plane) and the angle of incidence of the light to the glass sheet increases with distance away from the normal. The theoretical perceived (effective) glass thickness decreases with the distance from the middle of the optical sensor for a 0.5 mm flat glass sheet as shown in the chart of FIG. 5. This creates vertical thickness fringes as shown in FIG. 4. In the horizontal direction the laser light beam is almost perpendicular to the glass sheet, and the laser beam can be treated as collimated in this direction. This condition facilitates the phase unwrapping calculations. If the fringes create a circular pattern (named here focus) as shown in the center portion of FIG. 4, the glass thickness gradient has the same sign in all direction. Since we know that the effective thickness in the vertical direction is maximum at normal, the actual thickness in the horizontal x-direction will have a maximum. If it is a cross pattern (named here saddle) the thickness at this point is minimum in the x-direction. The black curve in FIG. 4 represents the thickness profile in the horizontal direction.

FIG. 6 shows a system that measures thickness of a glass according to another embodiment of the present disclosure. In the system of FIG. 6, a plurality of lasers 20 can be used to emit corresponding laser beams through the glass sheet 30 to provide interference patterns to corresponding optical line scan sensors 10. The optical line scan sensors 10 can be connected to transmit sensor data to a computer 50 including a memory that stores and processes the sensor data to determine thicknesses across several portions of the glass sheet 30. Although three lasers 20 and three optical line scan sensors 10 are shown in FIG. 6, any suitable number of lasers 20 and corresponding optical line scan sensors 10 can be incorporated into the system. In an alternative aspect of the disclosure, a plurality of lasers 20 can be used to provide interference patterns to one optical line scan sensor 10. Light beams from the sources may overlap in the vertical direction and placed in a staggered configuration in the x-direction to minimize or prevent light leakage from neighboring sources.

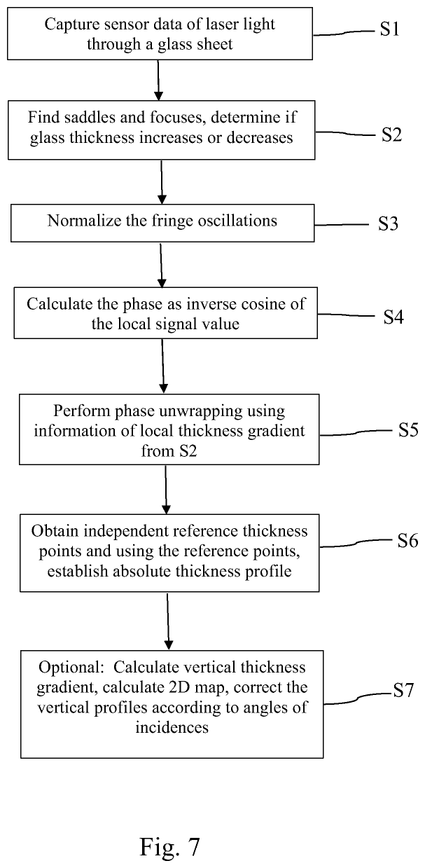

FIG. 7 is a flowchart of a method of contactless thickness measurement of a glass sheet according to an embodiment of the present disclosure. In an embodiment, at step S1, a glass sheet is passed between a laser and an optical line scan sensor as shown in FIGS. 1 and 2. Sensor data is captured by a computer to be processed.

At step S2, saddles and focuses positions of an interference fringe pattern are found in the sensor data. The interference fringe pattern is analyzed to find saddle and focus positions by searching for those patterns in the fringe image, as described below. They will determine for a given segment in which horizontal direction thickness is increasing and decreasing, for example, as shown in FIG. 4.

At step S3, the fringe oscillations are normalized. Local minimums and maximums are found, and a linear transformation is performed for each segment to make maximum values be equal to +1 and minimum values to be equal to −1.

At step S4, the phase of the oscillating normalized signal is calculated as inverse cosine. At this step the phase before unwrapping has values from 0 to π. It is referred to here as an initial phase.

At step S5, phase unwrapping is performed using the thickness decrease/increase information from step S2. For example, at one of the maximums of thickness, the unwrapped phase is set to 0. The unwrapped phase will be decreasing to the point where the initial phase reaches value π assuming that the following minimum is still not approached. After this point, the wrapped phase will start from the value it has reached and will keep decreasing until the minimum has been reached. Then the unwrapping process continues to the next maximum. On this segment the unwrapped phase will be increasing. When such unwrapping process is complete in both directions from initial point, the relative glass thickness d₀(x) has been obtained as

$${d}_{0} ( x ) = \frac{λ {φ}_{0} ( x )}{2 π n} ,$$

where λ is the laser wavelength, φ₀(x) is the unwrapped phase, and n is the index of refraction of the glass.

At step S6, an absolute thickness profile is established using at least one reference thickness measurement taken with a different instrument, for example using a sensor that contacts the glass. For example, if a reference thickness value obtained by the independent measurement d(x₁)=r₁ at reference point x₁, then the absolute thickness at any point x is calculated as

$$d ( x ) = C + {d}_{0} ( x ) ,$$

where constant C is given by:

$$C = {r}_{1} - {d}_{0} ( {x}_{1} ) .$$

If there are multiple points of reference thickness available, the constant can be obtained, for example, by minimizing the sum of squared thickness deviations for all reference points.

The reference thickness measurement can be obtained by placing an independent thickness gauge at a fixed position where the glass sheet will be within the working range of the thickness gauge at least once while the glass sheet is conveying passed the fixed position. Alternatively, the independent thickness gauge can be positioned on a stage that is oscillating in the z-direction such that the glass sheet will be within the working range of the sensor at least once during conveying. Time wise, step 6 can occur simultaneously with or even prior to step 1.

Optionally, step S7 can be included to find the vertical location on focus/saddle points and calculate a vertical thickness gradient. To calculate an estimate of the vertical thickness gradient, the vertical shifts in the sensor plane Δy of the center of focus and saddle points has to be extracted from the fringe pattern using an appropriate image processing method. Then the thickness gradient in the vertical direction at this point x is calculated as:

$$\frac{\partial d ( x , y )}{\partial y} = \frac{d ( x ) Δ y}{{S}_{1} S {n}^{2}} ,$$

where S is the distance from the laser to the sensor, S₁ is the distance from the laser to the glass, n is the index of refraction of the glass, and Δy is the vertical shift in the sensor plane of the center of focus or saddle points. Alternatively, using the same phase unwrapping method described above the vertical effective unwrapped phase φ(ϑ) is calculated, where D is the angle of incidence in the y-z plane.

The rest of the calculation is performed like the horizontal profile calculation. By repeating calculations for a set of the x position and converting angle of incidence to vertical glass position, the thickness map d(x, y) can be obtained.

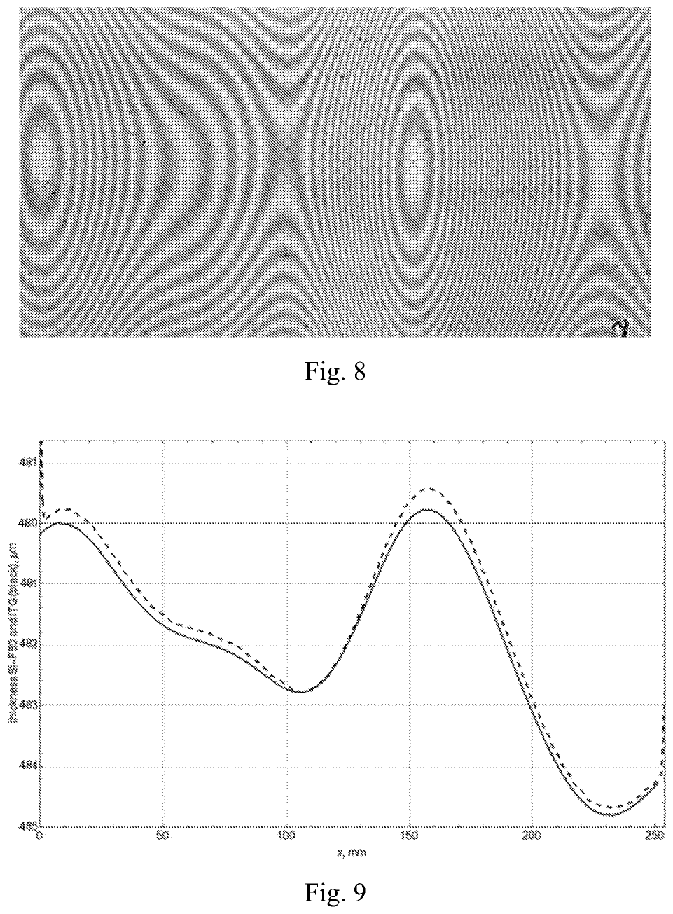

FIG. 8 is an example of an interference fringe pattern for a thickness measurement using the disclosed optical system. FIG. 8 shows an example of the fringe pattern of glass with approximately 0.48 mm actual thickness over a 250 mm length.

FIG. 9 is a comparison of thickness d(x) measured on a 250 mm long glass sheet by the disclosed method (solid line curve) and with independent measurements (dashed line curve) taken using a Keyence SI-F80 measurement sensor. The Keyence SI-F80 is a confocal thickness gauge. FIG. 9 demonstrates that deviation of the reconstructed profile using the disclosed measurement method is around 0.2 μm, which is within the variations of the three measurements taken with the SI-F80 meter.

Optionally, the reference thickness measurement can also be obtained from the vertical fringe pattern when the vertical thickness gradient is smaller than horizontal. This will eliminate necessity of obtaining a reference thickness measurement with a separate instrument. Feasibility of the absolute measurement will depend on the noise in the fringe pattern.

The above-described embodiments of the present disclosure can be implemented in any of numerous ways. For example, the embodiments can be implemented using hardware, software, or a combination thereof. When implemented in software, the software code can be executed on any suitable computer, processor, or collection of processors, whether provided in a single computer or distributed among multiple computers. Such processors can be implemented as integrated circuits, with one or more processors in an integrated circuit component. Though, a processor can be implemented using circuitry in any suitable format.

Additionally, or alternatively, the above-described embodiments can be implemented as a non-transitory computer readable storage medium embodied thereon a program executable by a processor that performs a method of various embodiments.

Also, the various methods or processes outlined herein can be coded as software that is executable on one or more processors that employ any one of a variety of operating systems or platforms. Additionally, such software can be written using any of a number of suitable programming languages and/or programming or scripting tools, and also can be compiled as executable machine language code or intermediate code that is executed on a framework or virtual machine. Typically, the functionality of the program modules can be combined or distributed as desired in various embodiments.

Also, the embodiments of the present disclosure can be embodied as a method, of which an example has been provided. The acts performed as part of the method can be ordered in any suitable way. Accordingly, embodiments can be constructed in which acts are performed in an order different than illustrated, which can include performing some acts concurrently, even though shown as sequential acts in illustrative embodiments.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. A system that measures thickness of a glass, the system comprising:
a laser that transmits a laser beam through the glass;
an imaging sensor that senses an interference pattern of the laser beam through the glass; and
a computer that processes sensor data corresponding to the interference pattern received from the sensor to determine the thickness of the glass.

2. The system of claim 1 wherein the glass is a glass sheet.

3. The system of claim 2, further comprising a conveying system that conveys the glass sheet between the laser and the sensor.

4. The system of claim 1, wherein the imaging sensor is an optical line scan sensor.

5. The system of claim 1, further comprising a band pass filter positioned between the glass and the sensor.

6. The system of claim 1, further comprising a plurality of lasers that each transmits a corresponding laser beam through the glass to a corresponding imaging sensor.

7. A method to measure thickness of a glass, the method comprising:
passing a glass sheet in a horizontal direction between a laser and an imaging sensor that senses an interference fringe pattern of laser light emitted from the laser through a portion of the glass;
capturing sensor data of the laser light from the imaging sensor by a computer;
analyzing the sensor data to locate saddle and focus positions by the computer;
normalizing the sensor data by the computer;
calculating the normalized sensor data as inverse cosine;
obtaining a reference thickness value of the glass; and
calculating an absolute thickness of the glass along the horizontal direction using the reference thickness value.

8. The method of claim 7, further comprising calculating a vertical thickness gradient of the glass.

9. The method of claim 8, wherein the vertical thickness gradient is calculated as:
$$\frac{\partial d ( x , y )}{\partial y} = \frac{d ( x ) Δ y}{{S}_{1} S {n}^{2}} ,$$
where S is a distance from the laser to the sensor, S₁ is a distance from the laser to the glass, n is an index of refraction of the glass, and Δy is a vertical shift in the sensor plane of the center of focus or saddle points.

10. The method of claim 7, wherein normalizing the sensor data includes identifying a maximum value and a minimum value of the sensor data and transforming the sensor data such that the maximum value is equal to 1 and the minimum value is equal to −1.

11. The method of claim 7, wherein the absolute thickness of the glass is calculated by adding a constant such that a thickness at a reference point is equal to the reference thickness value.

12. A non-transitory computer-readable medium including executable instructions that when executed by a processor cause the processor to perform a method comprising:
capturing sensor data of laser light that causes an interference fringe pattern when passed through glass and incident to an imaging sensor;
analyzing the sensor data to locate saddle and focus positions;
normalizing the sensor data;
calculating the normalized sensor data as inverse cosine; and
calculating an absolute thickness of the glass along the horizontal direction using a reference thickness value of the glass.

13. The non-transitory computer-readable medium of claim 12, wherein the method further comprises calculating a vertical thickness gradient of the glass.

14. The non-transitory computer-readable medium of claim 13, wherein the vertical thickness gradient is calculated as:
$$\frac{\partial d ( x , y )}{\partial y} = \frac{d ( x ) Δ y}{{S}_{1} S {n}^{2}} ,$$
where S is a distance from the laser to the sensor, S₁ is a distance from the laser to the glass, n is an index of refraction of the glass, and Δy is a vertical shift of the sensor plane of the center of focus or saddle points.

15. The non-transitory computer-readable medium of claim 12, wherein normalizing the sensor data includes identifying a maximum and a minimum value of the sensor data and transforming the sensor data such that the maximum value is equal to 1 and the minimum value is equal to −1.

16. The non-transitory computer-readable medium of claim 12, wherein the absolute thickness of the glass is calculated by adding a constant such that a thickness at a reference point is equal to the reference thickness value.
